(19) United States
(12) Patent Application Publication
(10) Pub. No.: US 2024/0323503 A1
(43) Pub. Date: Sep. 26, 2024

(54) IMAGE SENSOR ASSEMBLY

(71) Applicant: ZF Friedrichshafen AG, Friedrichshafen (DE)

(72) Inventors: Thomas E. Blake, III, Novi, MI (US); Grzegorz Ciosk, Tychy (PL)

(21) Appl. No.: 18/187,037

(22) Filed: Mar. 21, 2023

(51) Int. Cl. H04N 23/54; G03B 9/58; H04N 23/51; H04N 23/55

(52) U.S. Cl. CPC H04N 23/54; G03B 9/58; H04N 23/51; H04N 23/55

(57) ABSTRACT

An image sensor assembly can include a lens assembly that includes a lens housing and a lens barrel disposed around the lens housing. The image sensor assembly can also include a socket. The socket can include a socket body having a plurality of socket fingers that allow the socket body to transition between a deflected state and a non-deflected state.

### TECHNICAL FIELD

The present disclosure relates to electronics and, more specifically, relates to an image sensor assembly including a lens assembly housing configured to reduce axis alignment issues.

### BACKGROUND

In some known camera assembly arrangements, mounting bosses for a lens mount correspond to counterbores within a housing configured to receive the lens mount. Such an arrangement can establish yaw, pitch, and/or roll between the lens mount and the housing. However, an issue that occurs is that tolerances related to yaw and pitch can deteriorate due to insufficient contact surface. Additionally, tolerances for various axis alignments can be reduced due to the counterbore formation process.

### SUMMARY

An image sensor assembly can include a lens assembly that includes a lens housing and a lens barrel disposed around the lens housing. The image sensor assembly can also include a socket. The socket can include a socket body having a plurality of socket fingers that allow the socket body to transition between a deflected state and a non-deflected state.

In another exemplary arrangement, the socket body includes a plurality of castellations.

In another exemplary arrangement, the image sensor assembly includes an adhesive material disposed between the plurality of castellations.

In another exemplary arrangement, the socket body comprises a plurality of grooves that define the plurality of socket fingers.

In another exemplary arrangement, the socket body further comprises an internal ridge portion that is displaced by the lens barrel when the socket body is in the deflected state.

In another exemplary arrangement, the lens barrel is integral with the lens housing.

In another exemplary arrangement, the lens barrel comprises a spherical shape.

In another exemplary arrangement, the lens barrel and the socket form a ball and socket interface when the socket is positioned over the lens barrel.

In another exemplary arrangement, the image sensor assembly includes a housing that defines an opening for receiving the lens assembly.

An image sensor assembly can include a lens assembly that includes a lens housing and a lens barrel disposed around the lens housing. The image sensor assembly can also include a socket. The socket can include a socket body having a plurality of castellations and a plurality of socket fingers that allow the socket body to transition between a deflected state and a non-deflected state.

In another exemplary arrangement, the image sensor assembly includes an adhesive material disposed between the plurality of castellations.

In another exemplary arrangement, the image sensor assembly includes an image sensor mounted on the rigid substrate.

In another exemplary arrangement, the socket body comprises a plurality of grooves that define the plurality of socket fingers.

In another exemplary arrangement, the socket body further comprises an internal ridge portion that is displaced by the lens barrel when the socket body is in the deflected state.

In another exemplary arrangement, the lens barrel comprises a spherical shape.

In another exemplary arrangement, the lens barrel and the socket form a ball and socket interface when the socket is positioned over the lens barrel.

In another exemplary arrangement, the image sensor assembly includes a housing that defines an opening for receiving the lens assembly.

An image sensor assembly can include a housing defining an opening and a lens assembly that is received by the housing through the opening. The lens assembly includes a lens housing and a lens barrel disposed around the lens housing. The image sensor assembly can also include a socket. The socket can include a socket body having a plurality of castellations and a plurality of socket fingers that allow the socket body to transition between a deflected state and a non-deflected state.

In another exemplary arrangement, the image sensor assembly includes a rigid substrate and an image sensor mounted on the rigid substrate, where the lens assembly is positioned over the image sensor and attached to the rigid substrate.

In another exemplary arrangement, the image sensor assembly includes an adhesive material disposed between the plurality of castellations.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a partially exploded an isometric view of an image sensor assembly according to an exemplary arrangement of the present disclosure;

FIG. 2 is an assembled isometric view of the image sensor assembly according to an exemplary arrangement of the present disclosure;

FIG. 3 is bottom isometric view of the image sensor assembly according to an exemplary arrangement of the present disclosure;

FIG. 4 is a partial isometric cross-sectional view of a socket according to an exemplary arrangement of the present disclosure;

FIG. 5 is a partially exploded isometric view of an image sensor assembly and the socket according to an exemplary arrangement of the present disclosure;

FIG. 6 is an assembled isometric view of an image sensor assembly and the socket according to an exemplary arrangement of the present disclosure;

FIG. 7 is a side cross-sectional view of the image sensor assembly received by a housing according to an exemplary arrangement of the present disclosure;

FIG. 8 is a partially exploded isometric view of an image sensor assembly according to an exemplary arrangement of the present disclosure;

FIG. 9 is an assembled isometric view of the image sensor assembly according to an exemplary arrangement of the present disclosure;

FIG. 10 is bottom isometric view of the image sensor assembly according to an exemplary arrangement of the present disclosure;

FIG. 11 is an isometric view of a housing that can receive the image sensor assembly according to an exemplary arrangement of the present disclosure;

FIG. 12 is a side cross-sectional view of the image sensor assembly received by a housing according to an exemplary arrangement of the present disclosure;

FIG. 13 is a partially exploded isometric view of an image sensor assembly according to an exemplary arrangement of the present disclosure;

FIG. 14 is an assembled isometric view of the image sensor assembly according to an exemplary arrangement of the present disclosure;

FIG. 15 is an isometric view of an image sensor assembly according to an exemplary arrangement of the present disclosure;

FIG. 16 is a partial side cross-sectional view of the image sensor assembly received by a housing according to an exemplary arrangement of the present disclosure;

FIG. 17 is an enlarged partial side cross-sectional view of a portion of the image sensor assembly from FIG. 16 according to an exemplary arrangement of the present disclosure;

FIG. 18 is a side view of an image sensor assembly according to an exemplary arrangement of the present disclosure;

FIG. 19 is a side view of an image sensor assembly according to an exemplary arrangement of the present disclosure;

FIG. 20 is a partial side cross-sectional view of the image sensor assembly received by a housing according to an exemplary arrangement of the present disclosure;

FIG. 21 is a partial side cross-sectional view of the image sensor assembly received by a housing according to an exemplary arrangement of the present disclosure;

FIG. 22 is a partial side cross-sectional view of the image sensor assembly received by a housing according to an exemplary arrangement of the present disclosure;

FIG. 23 is a partial side cross-sectional view of the image sensor assembly received by a housing according to an exemplary arrangement of the present disclosure; and

FIG. 24 is a partial side cross-sectional view of the image sensor assembly received by a housing according to an exemplary arrangement of the present disclosure.

### DETAILED DESCRIPTION

The following description is merely exemplary in nature and is not intended to limit the present disclosure, application, or uses.

The present disclosure describes one or more exemplary arrangements of an image sensor assembly that includes lens assembly that can be manipulated after the lens assembly is retained within a housing. For example, as discussed herein, a ball and socket interface may be created to allow for the alignment and selective re-alignment of the lens assembly after the lens assembly is received by a housing, which may improve axis alignment tolerances.

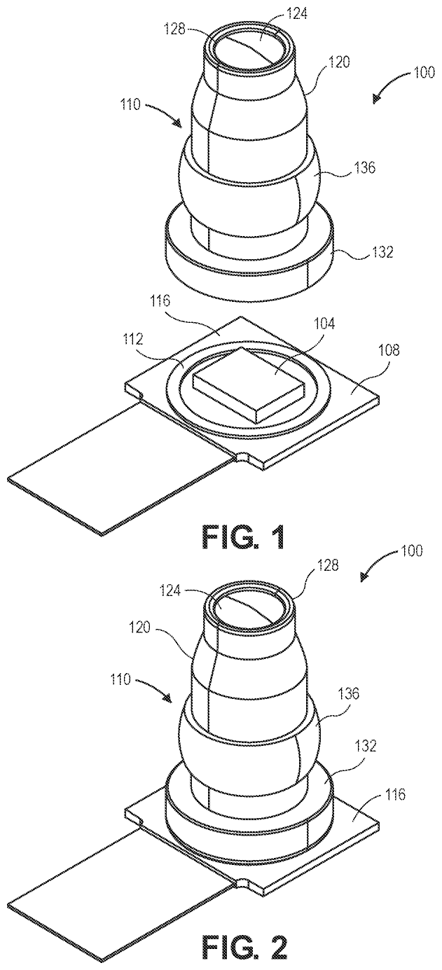

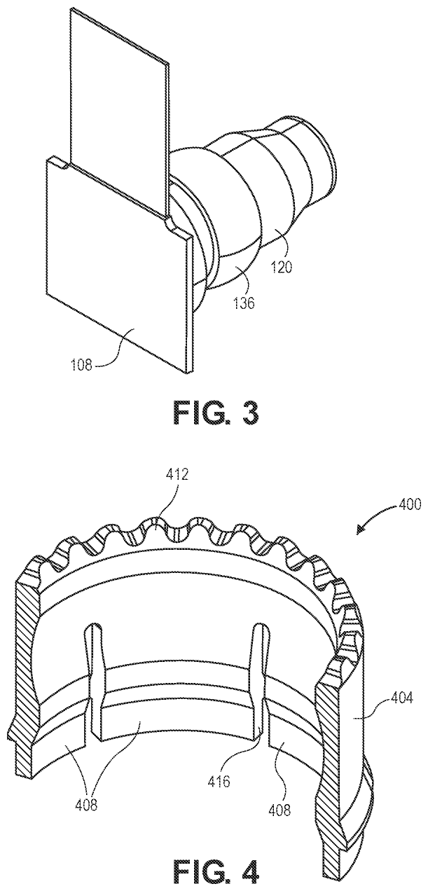

FIGS. 1 through 3 illustrate an image sensor assembly 100 according to an exemplary arrangement. The image sensor assembly 100 includes an image sensor 104 mounted to a rigid substrate 108 and a lens assembly 110.

In one exemplary arrangement, the lens assembly 110 may be mounted to the rigid substrate 108. For example, the lens assembly 110 is positioned over and attached to the rigid substrate 108 using an adhesive material 112. In one exemplary arrangement, the adhesive material 112 is applied to a top surface 116 of the rigid substrate 108. In an exemplary arrangement, the adhesive material 112 comprises a suitable adhesive material, such as an epoxy cationic material, that is used to retain the lens assembly 110.

The lens assembly 110 includes a lens housing 120 that retains a lens 124 at a first end 128. As shown, when assembled, the first end 128 is positioned opposite the top surface 116 of the rigid substrate 108. A base portion 132 of the lens housing 120 can be affixed to the top surface 116 via the adhesive material 112.

When assembled, the lens housing 120 can comprise a generally cylindrical shape and extends outwardly from the rigid substrate 108. The lens housing 120 may include a lens barrel 136 that is positioned between the first end 128 and the base portion 132. In an exemplary arrangement, the lens barrel 136 may be integral with the lens housing 120. In another exemplary arrangement, the lens barrel 136 may be separate from the lens housing 120. In other words, the lens barrel 136 may be manufactured distinctly from the lens housing 120, i.e., attached to the lens housing 120 after the lens housing 120 and the lens barrel 136 are manufactured. As shown, the lens barrel 136 comprises a generally spherical shape to allow for a ball and socket joint configuration as described below.

FIG. 4 illustrates a socket 400 comprising a socket body 404, multiple socket fingers 408, and multiple castellations 412. As shown, the socket fingers 408 may be defined by multiple grooves 416 within the socket body 404. The socket fingers 408 allow for the socket body 404 to deflect outwardly, i.e., a deflected state, when an interior ridge portion is displaced by the lens barrel 136 (as shown in FIG. 6, for example) and return to a non-deflected state when the ridge portion is not displaced by the lens barrel 136.

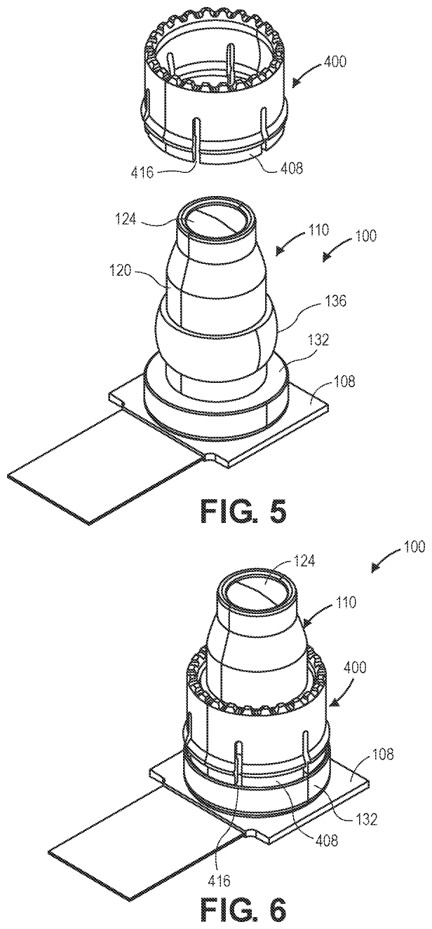

As shown in FIGS. 5 and 6, the socket 400 may be removably attached to an exterior of the lens housing 120. In an exemplary arrangement, the lens housing 120 may receive the socket 400 such that the lens barrel 136 and the socket 400 cooperate to form a ball and socket interface.

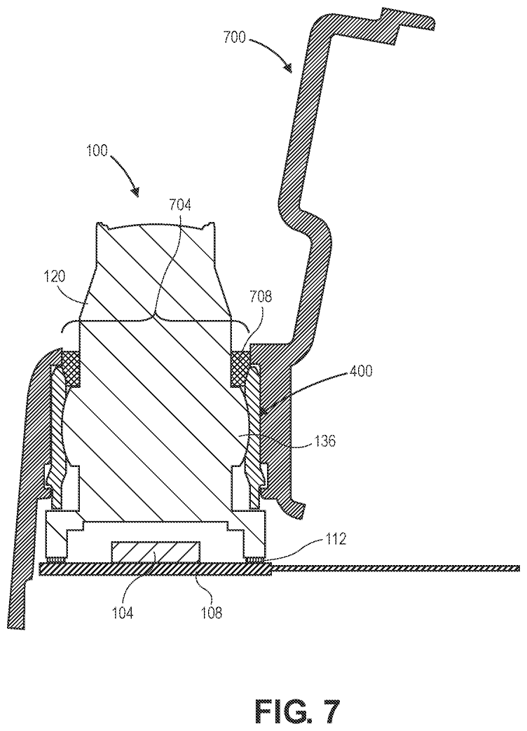

As shown in FIG. 7, the lens assembly 110 is retained within a housing 700. The housing 700 defines an opening 704 to receive the lens assembly 110. Once positioned within the housing 700, one or more of a roll, a pitch, or a yaw of the lens assembly 110 may be manipulated via a tool, such as a gripper. For instance, a manufacturer can use the tool to manipulate the lens housing 120 relative to the socket 400 through the ball and socket interface. Once the lens housing 120 sufficiently manipulated to minimize detrimental effects of the roll, the pitch, and/or the yaw, an adhesive material 708 is dispensed between the castellations 412 of the lens barrel 136 to bond the lens barrel 136, the socket 400, and the housing 700 to one another to fixably establish orientation of the lens barrel 136 relative to the housing 700 with respect to yaw, pitch, and/or roll.

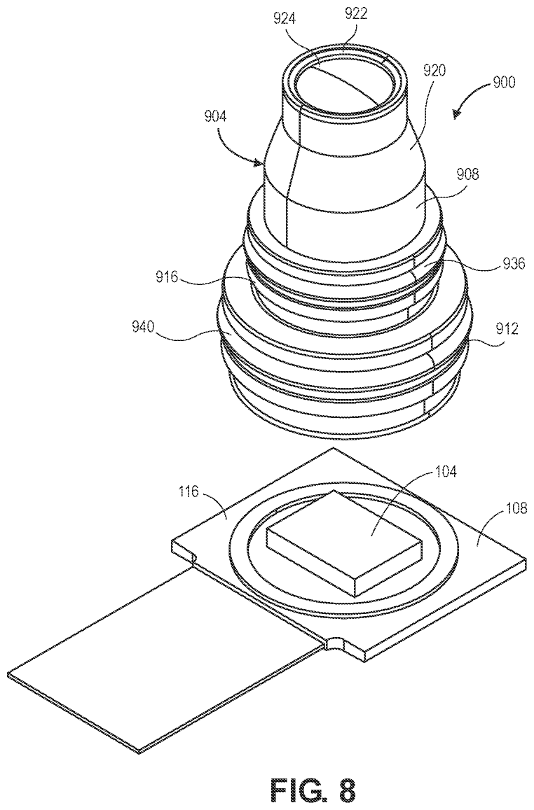

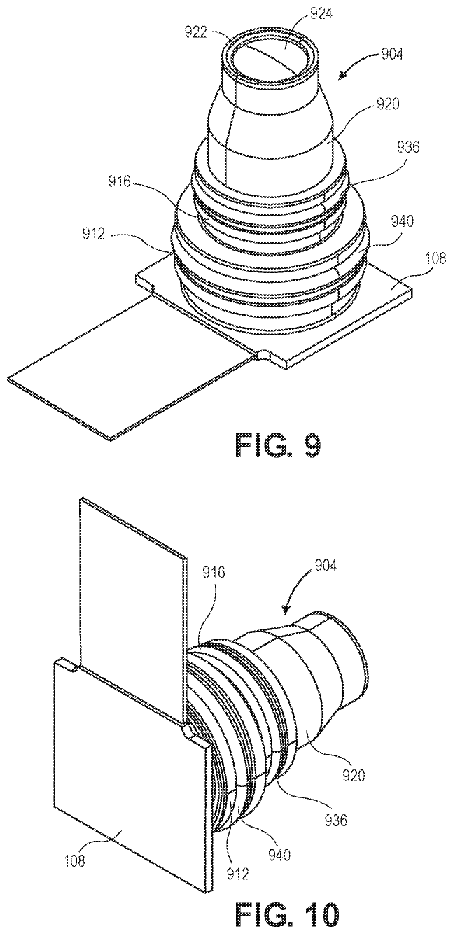

FIGS. 8 through 10 illustrate an image sensor assembly 900 according to another exemplary arrangement. As shown, the sensor assembly 900 includes the image sensor 104 that is mounted to the rigid substrate 108. The image sensor assembly 900 also includes a lens assembly 904 that is retained over the top surface 116 of the rigid substrate 108. The lens assembly 904 includes a lens housing 908 that comprises a base portion 912, an intermediate portion 916, and a top portion 920.

As shown in FIGS. 8 through 10, the base portion 912, the intermediate portion 916, and the top portion 920 are generally cylindrical. In an exemplary arrangement, a radius of the base portion 912 is greater than a radius of the intermediate portion 916. In this exemplary arrangement, the radius of the intermediate portion 916 is greater than a radius of the top portion 920. The top portion 920 defines an opening 922 and retains a lens 924 therein.

The base portion 912 and the intermediate portion 916 both define channels that can each receive and retain an O-ring 936, 940. The O-rings 936, 940 can function to seal a cavity for receiving an adhesive material (as explained in further detail below) and/or dampen vibration experienced by the lens assembly 904.

Similar to the exemplary arrangement described above, the lens assembly 904 may also be actuated by a tool, such as a gripper once the lens assembly 904 is retained within a housing.

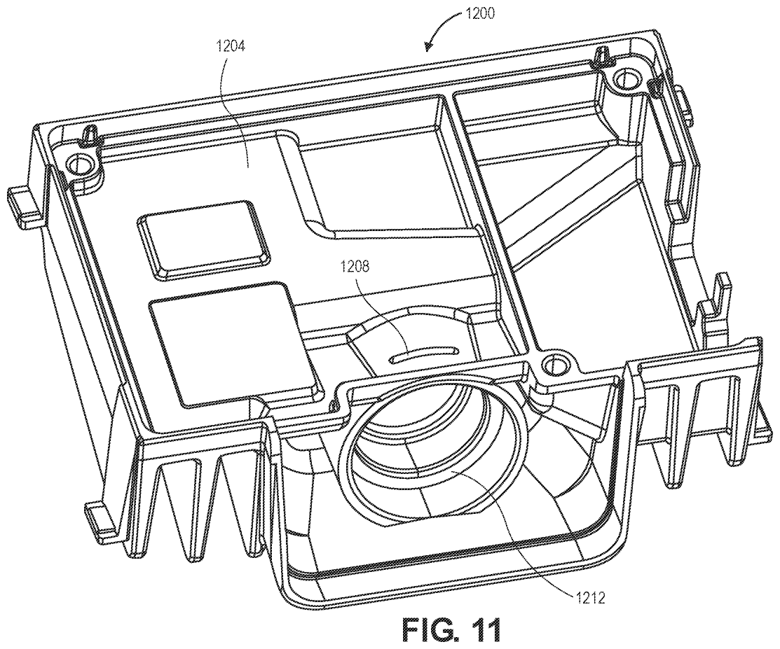

FIG. 11 illustrates an example housing 1200 having a housing body 1204. The housing body 1204 can define a channel 1208 in which an adhesive can be dispensed when the image sensor assembly 900 is positioned within the housing 1200. The housing body 1204 also defines an opening 1212 to receive the image sensor assembly 900.

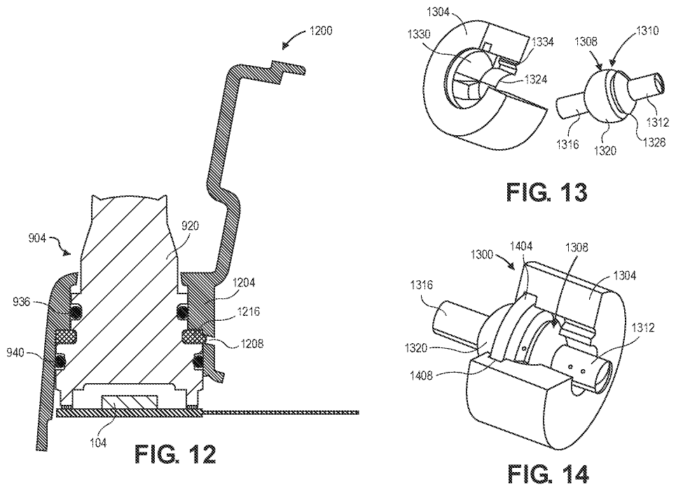

Once the image sensor assembly 900 is seated within the channel 1208 and then oriented to a desired position as shown in FIG. 12, an adhesive material 1216 can be dispensed into a channel 1204 defined within the housing 1200. The adhesive material 1216 is disposed between the O-rings 936, 940 and serves to maintain a position of the lens assembly 904 relative to the housing 1200.

FIGS. 13 and 14 illustrate an image sensor assembly 1300 according to another exemplary arrangement. The image sensor assembly 1300 can include a housing 1304 that can receive a lens assembly 1308. The lens assembly 1308 can comprise a lens housing 1310 that includes a first cylindrical portion 1312, a second cylindrical portion 1316, and a generally spherical portion 1320. The generally spherical portion 1320 can be positioned between the cylindrical portions 1312, 1316.

The housing 1304 can comprise a generally torus structure that defines a first opening 1324 through which the first cylindrical portion 1312 extends. As shown in FIG. 13, the housing 1304 may define an inner spherical surface 1330 such that the housing 1304 may receive the generally spherical portion 1320 of the lens assembly 1308 to form a ball and socket interface. The generally spherical portion 1320 defines a groove 1328 that receives an adhesive when positioned in the housing 1304. For instance, an adhesive material can be provided via a feed channel 1334 defined within the housing 1304. The lens assembly 1308 can be adjusted in multiple axes due to the ball and socket interface.

Referring to FIG. 14, an O-ring 1404 can be positioned around the generally spherical portion 1320 to maintain the lens assembly 1308 within the housing 1304 during adjustment of the lens assembly 1308. The O-ring 1404 is retained within a groove 1408 that is defined within the housing 1304.

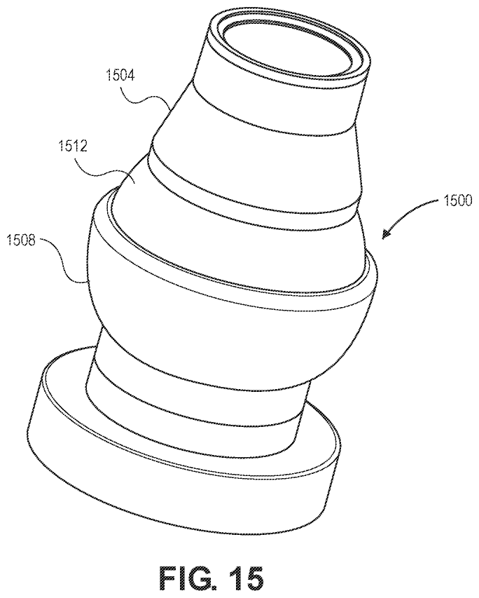

As shown in FIG. 15, an image sensor assembly 1500 can include a lens housing 1504 having a first concentric sphere 1508 and a second concentric sphere 1512. The concentric spheres 1508, 1512 allow for roll, pitch, and/or yaw orientation adjustment relative to the image sensor 104. According to an exemplary arrangement, a maximum radius of the first concentric sphere 1508 is greater than a maximum radius of the second concentric sphere 1512.

As shown in FIG. 16, the image sensor assembly 1500 can be retained within a housing 1600 that includes a housing body 1604. The housing body 1604 defines a first opening 1608 that can receive the lens housing 1504. Further, the housing body 1604 defines a second opening 1609 spaced from the first opening 1608. When the lens housing 1504 is disposed within the housing 1600, a portion of the lens housing 1504 extends through the second opening 1609.

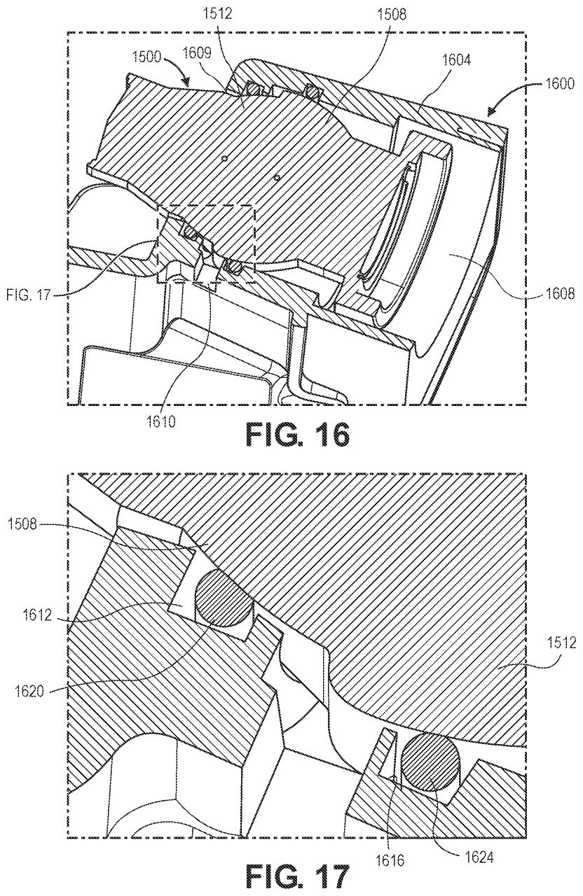

The housing 1600 further includes a third opening 1610 that is in communication with an interior of the housing 1600 and may be used to deliver adhesive within the housing 1600 to maintain the image sensor assembly 1500 relative to the housing 1600 at a selected position. As shown in FIG. 17, the housing body 1604 defines a first interior groove 1612 and a second interior groove 1616. The grooves 1612, 1616 may retain respective O-rings 1620, 1624 that serve to provide sealing capabilities to the lens housing 104 and maintain the adhesive therebetween. The O-ring 1624 disposed about the second concentric sphere 1512 can also maintain the lens housing 1504 position relative to the housing 1600 when angular adjustments are taking place.

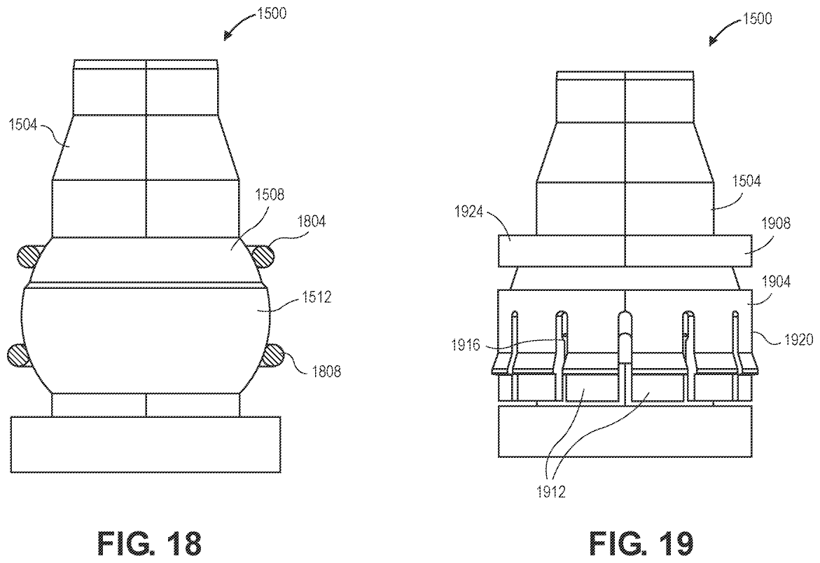

FIGS. 18 through 24 illustrate additional exemplary arrangements of the image sensor assemblies.

As shown in FIG. 18, a first O-ring 1804 is retained around a first concentric sphere 1508 of the image sensor assembly 1500 and a second O-ring 1808 is retained around the second concentric sphere 1512 of the image sensor assembly 1500 to allow for three axis re-alignment of the image sensor assembly 1500. Once retained within a housing, adhesive can be dispensed normal to an axis defined by the lens housing 1504, and between the O-rings 1804 and 1808.

FIG. 19 illustrates a first socket 1904 and a second socket 1908 retained about the lens housing 1504 of the image sensor assembly 1500. The first socket 1904 includes multiple socket fingers 1912 that are defined by multiple grooves 1916 defined within a socket body 1920 of the first socket 1904. A socket body 1924 of the second socket 1908 is generally defined as a torus structure. The sockets 1904, 1908 can comprise an elastomeric material, such as a polymer. As shown, the first socket 1904 is generally retained about the first concentric sphere 1512, and the second socket 1908 is generally retained about the second concentric sphere 1508.

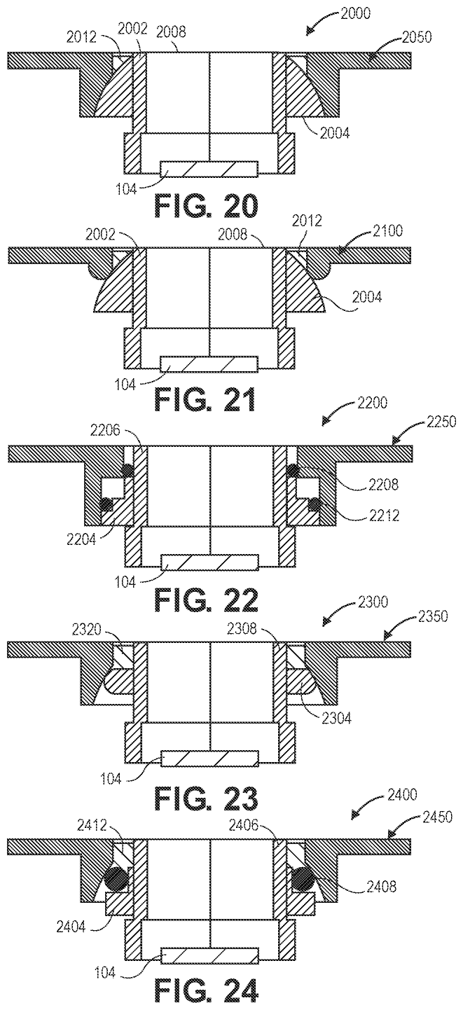

Referring to FIGS. 20 and 21, an image sensor assembly 2000 includes a lens housing 2002 and a flange 2004 positioned around an outer end 2008 of the lens housing 2002. The flange 2004 can be retained within an opening of the respective housing 2050, 2100. An adhesive material 2012 can maintain the lens housing 2002 relative to the corresponding housing 2050, 2100.

As shown in FIG. 22, an image sensor assembly 2200 can include a stair-step flange 2204 positioned about a lens housing 2206. A first O-ring 2208 and a second O-ring 2212 are positioned about the stair-step flange 2204 for sealing purposes when the image sensor assembly 2200 is retained within a housing 2250.

FIG. 23 illustrates an image sensor assembly 2300 that includes a generally spherical flange 2304 about a lens housing 2308. The flange 2304 can be retained within an opening of a housing 2350, and an adhesive material 2320 may be disposed between the housing 2350 and the lens housing 2308 to maintain the lens housing 2308 relative to the housing 2350.

FIG. 24 illustrates an image sensor assembly 2400 that includes a stair-step flange 2404 positioned about a lens housing 2406. As shown, an O-ring 2408 is positioned on the stair-step flange 2404. An adhesive material 2412 may be disposed between a housing 2450 and the lens housing 2406 to maintain the lens housing 2406 relative to the housing 2450.

Accordingly, it is to be understood that the above description is intended to be illustrative and not restrictive. Many implementations and applications other than the examples provided would be apparent to those of skill in the art upon reading the above description. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. An image sensor assembly, comprising:
a lens assembly including a lens housing and a lens barrel disposed around the lens housing; and
a socket including a socket body, the socket body including a plurality of socket fingers that allow the socket body to transition between a deflected state and a non-deflected state.

2. The image sensor assembly as recited in claim 1, wherein the socket body includes a plurality of castellations.

3. The image sensor assembly as recited in claim 2, further comprising an adhesive material disposed between the plurality of castellations.

4. The image sensor assembly as recited in claim 1, wherein the socket body comprises a plurality of grooves that define the plurality of socket fingers.

5. The image sensor assembly as recited in claim 1, wherein the socket body further comprises an internal ridge portion that is displaced by the lens barrel when the socket body is in the deflected state.

6. The image sensor assembly as recited in claim 1, wherein the lens barrel is integral with the lens housing.

7. The image sensor assembly as recited in claim 1, wherein the lens barrel comprises a spherical shape.

8. The image sensor assembly as recited in claim 1, wherein the lens barrel and the socket form a ball and socket interface when the socket is positioned over the lens barrel.

9. The image sensor assembly as recited in claim 1, further comprising a housing that defines an opening for receiving the lens assembly.

10. An image sensor assembly, comprising:
a lens assembly including a lens housing and a lens barrel disposed around the lens housing; and
a socket including a socket body, the socket body including a plurality of castellations and a plurality of socket fingers, wherein the plurality of socket fingers allow the socket body to transition between a deflected state and a non-deflected state.

11. The image sensor assembly as recited in claim 10, further comprising an adhesive material disposed between the plurality of castellations.

12. The image sensor assembly as recited in claim 10, wherein the socket body comprises a plurality of grooves that define the plurality of socket fingers.

13. The image sensor assembly as recited in claim 10, wherein the socket body further comprises an internal ridge portion that is displaced by the lens barrel when the socket body is in the deflected state.

14. The image sensor assembly as recited in claim 10, wherein the lens barrel is integral with the lens housing.

15. The image sensor assembly as recited in claim 10, wherein the lens barrel comprises a spherical shape.

16. The image sensor assembly as recited in claim 10, wherein the lens barrel and the socket form a ball and socket interface when the socket is positioned over the lens barrel.

17. The image sensor assembly as recited in claim 10, further comprising a housing that defines an opening for receiving the lens assembly.

18. An image sensor assembly, comprising:
a housing defining an opening;
a lens assembly received by the housing through the opening, the lens assembly including a lens housing and a lens barrel disposed around the lens housing; and
a socket including a socket body, the socket body including a plurality of castellations and a plurality of socket fingers, wherein the plurality of socket fingers allow the socket body to transition between a deflected state and a non-deflected state.

19. The image sensor assembly as recited in claim 18, further comprising a rigid substrate, an image sensor mounted on the rigid substrate, wherein the lens assembly is positioned over the image sensor and attached to the rigid substrate.

20. The image sensor assembly as recited in claim 18, further comprising an adhesive material disposed between the plurality of castellations.
